(19) United States
(12) Patent Application Publication
(10) Pub. No.: US 2018/0139189 A1
(43) Pub. Date: May 17, 2018

(54) DYNAMICALLY VARIABLE ENCRYPTION SYSTEMS AND METHODS

(71) Applicant: Mark Nataros, Austin, TX (US)

(72) Inventor: Mark Nataros, Austin, TX (US)

(21) Appl. No.: 15/350,047

(22) Filed: Nov. 12, 2016

(51) Int. Cl. H04L 29/06

(52) U.S. Cl. CPC H04L 63/0457; H04L 63/0823

(57) ABSTRACT

A system that includes client server and a client front end communicably coupled via a data stream, wherein the data stream includes encryption notification packets, thereby enabling dynamically variable encryption modes.

### STATEMENT OF PRIORITY

The present application claims priority to U.S. Provisional Application No. 62/254,694, titled “Dynamically Variable Encryption Systems and Methods” and filed Nov. 12, 2015.

### TECHNICAL FIELD

The present disclosure relates to data encryption and, more specifically, dynamically variable encryption modes.

### BACKGROUND

Nearly every form of communication involves encryption of the data being transferred, thereby preventing unauthorized users from obtaining or “hacking” private information. Such data can range from well-known encrypted data, such as passwords and logins, to lesser known data such as telephone and cellular phone communications.

Typically, in the process of establishing a data communication stream or channel between two devices, the data encryption mode is statically configured, therefore all communications on that data stream are encrypted and decrypted using the same data encryption mode which cannot be changed. For example, if the data encryption mode is 256 bit encryption, but a user then wishes to transfer more sensitive data which they may desire a higher data encryption mode (e.g., 1024 or 2048 bit encryption), such is not possible and the sensitive data will be transferred at the 256 bit encryption along with all the other data.

If one wishes to change the data encryption mode, the current communication stream has to be terminated, and another communication stream must be established with the newly desired data encryption mode. Downsides of having to perform such an invasive action include interruption of data, which can result in loss of data, and/or can simply result in inconvenience, for example if a user were to be streaming audio or video data. Addition downsides include increased transfer time due to the termination and re-establishment of the communication stream.

Accordingly, improved systems and methods for dynamically variable encryption mode remain highly desirable.

### BRIEF DESCRIPTION OF THE DRAWINGS

The following figures are included to illustrate certain aspects of the present invention, and should not be viewed as an exclusive embodiments. The subject matter disclosed is capable of considerable modification, alteration, and equivalents in form and function, as will occur to one having ordinary skill in the art and the benefit of this disclosure.

FIG. 1 is a data transfer system, according to one or more embodiments.

FIG. 2 is a data transfer diagram, according to one or more embodiments.

FIG. 3 is a block diagram of a computing device, according to one or more embodiments.

### DETAILED DESCRIPTION

The present disclosure relates to data encryption and, more specifically, dynamically variable encryption modes. In one embodiment, the present disclosure includes a system that employs a client server installed with software a user desires to use, and which communicates with a client front end to transfer and/or stream data thereto. Advantageously, the communication stream between the client server and client front end enables dynamically variable encryption modes. In other words, the encryption mode can be changed without having to terminate the initial communication stream and start another communication stream with a different desired encryption mode. In further embodiments, the system may include an authentications server configured to control the encryption mode for one or more parts of the entire system.

As used herein, a “processor” may be comprised of, for example and without limitation, one or more processors (each processor having one or more cores), microprocessors, field programmable gate arrays (FPGA' s), application specific integrated circuits (ASICs) or other types of processing units that may interpret and execute instructions as known to those skilled in the art.

As used herein, “memory” may be any type of storage or memory known to those skilled in the art capable of storing data and/or executable instructions. Memory may include volatile memory (e.g., RAM), non-volatile memory (e.g., hard-drives), or a combination thereof. Examples of such include, without limitation, all variations of non-transitory computer-readable hard disk drives, inclusive of solid-state drives. Further examples of such may include RAM external to a computer or controller or internal thereto (e.g., “on-board memory”). Example embodiments of RAM may include, without limitation, volatile or non-volatile memory, DDR memory, Flash Memory, EPROM, ROM, or various other forms, or any combination thereof generally known as memory or RAM. The RAM, hard drive, and/or controller may work in combination to store and/or execute instructions.

Referring now to the drawings, wherein like reference numbers are used herein to designate like elements throughout the various views and embodiments of a unit. The figures are not necessarily drawn to scale, and in some instances the drawings have been exaggerated and/or simplified in places for illustrative purposes only. One of the ordinary skill in the art will appreciate the many possible applications and variations based on the following examples of possible embodiments. As used herein, the “present disclosure” refers to any one of the embodiments described throughout this document and does not mean that all claimed embodiments must include the referenced aspects.

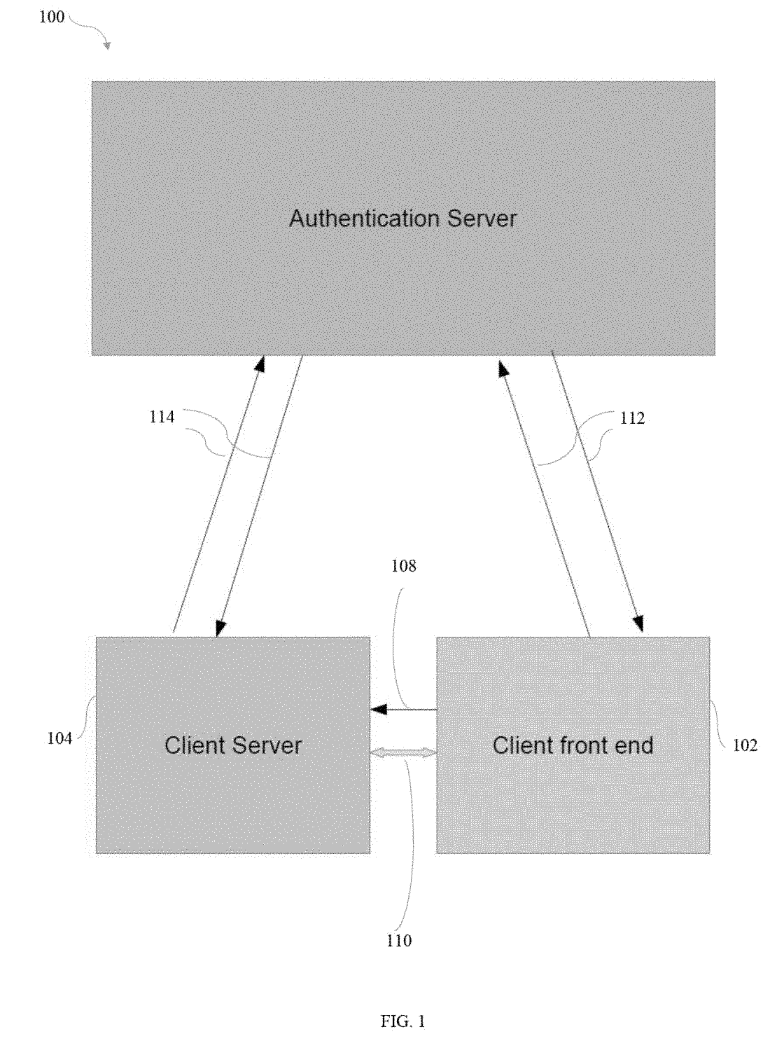

FIG. 1 is a data transfer system 100, according to one or more embodiments. As depicted, the system 100 includes a client front end 102, a client server 104, and an authentication server 106. For example and without limitation, the client front end 102 may be a desktop computer, or may be a more portable computing device, such as a laptop, tablet, iPad, cellular telephone, or the like. The client server 104 is the primary computer in which the client front end 102 communicates with as the client server 104 may include software which the client front end 102 wishes to access and/or data to be sent and/or streamed to the client front end 102. The client server 104 may be any type of server known to those skill in the art, including but not limited to, a desktop server, blade server, or cloud computing network.

In some embodiments, the system 100 further includes the authentication server 106, detailed below, which is responsible for initially configuring communication between the client front end 102 and the client server 104, and additionally sending license keys (and updated licenses) to the client server 104. Similar to the client server 104, the authentication server 106 may be, for example and without limitation, a desktop server, blade server, or cloud computing network. Moreover, in some embodiments, the authentication server 106 may be a separate computer from the client server 104, while in other embodiments, the client server 104 and the authentication server 106 may be hosted or run on the same server hardware.

While FIG. 1 depicts an embodiment containing only a single client front end 102, client server 104, and authentication server 106, such should not be construed as limiting. One of skill in the art will readily appreciate that other embodiments of the system 100 may include numerous client front ends 102, client servers 104, and/or authentication servers 106.

The client front end 102 is communicably coupled to the client server 104 via a first communication channel 108. Upon a successful connection with the client server 104, a pipe or data stream 110 is established therebetween which transfers a substantial majority of the data. The client front end 102 is further communicably coupled to the authentication server 106 via a second communication channel 112. The system 100 further includes a third communication channel 114 between the authentication server 106 and the client server 104. The third communication channel 114 can be used to register the client server 104 with the authentication server 106, and for the authentication server 106 to send licenses to the client server 104. In one embodiment, one or more of the first, second, and/or third communication channel, 108, 112, and 114, accordingly, can be implemented using the RSA encryption method as known to those skilled in the art.

In one exemplary operation, after the authentication server 106 has booted up and after the client server 104 has booted up, a secure connection is established therebetween via the third communication channel 114. During or shortly after the established connection, the client server 104 may communicate information to the authentication server 106, such as the client server's 104 specifications, unique ID, or other information enabling the authentication server 106 to recognize the client server 104. The authentication server 106 takes this information and may determine a particular set or subset of client front ends 102 which will be allowed to connect to the client server 104.

The client front end 102 also connects to the authentication server 106, doing so via the second communication channel 112. In one embodiment, the client front end 102 sends information to the authentication server 106 such as a user name and login password. Upon approval of the client front end 102 credentials, the authentication server 106 may return a list of client servers 104 available which the client front end 102 may use. The client front end 102 (or user thereof) selects which client server 104 they so desire, and such a selection is returned to the authentication server 106. The client front end 102 and the client server 104 instantiate the first communication channel 108, and then may instantiate the data stream 110.

As depicted, the data stream 110 is instantiated with an initial data encryption mode. However, as described below, in one embodiment, the data stream 110 data encryption mode can be changed “on-the-fly” or without having to terminate the data stream 110 and instantiate a new data stream 110 with a different data encryption mode.

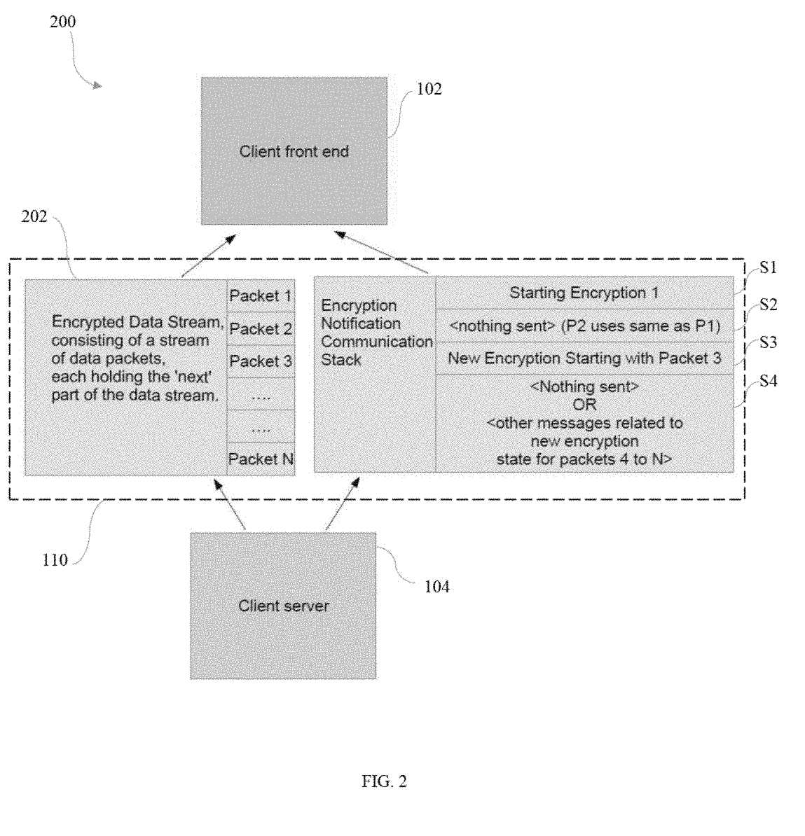

FIG. 2 depicts a data transfer diagram 200, according to one or more embodiments. In one embodiment, the diagram 200 may represent the data stream 110 between the client front end 102 and the client server 104. As depicted, data is being originated at the client server 104 and sent to the client front end 102. Such data may be, for example and without limitation, documents or videos stored on the client server 104 which the user at the client front end 102 wishes to access. However, one of skill in the art will appreciate the concepts discussed herein are applicable to the reverse as well, where data is originated at the client front end 102 and sent to the client server 104, for example and without limitation, keyboard and mouse controls.

The data stream 110 as depicted includes two streams—an encrypted data stream 202 and an encryption notification stack 204. The encrypted data stream 202 includes data packets 1 to N which represent the actual data being transferred from the client server 104 to the client front end 102. The encryption notification stack 204 includes numerous stack messages which represent various encryption modes, depicted as a first stack message S1, a second stack message S2, a third stack message S3, and a fourth stack message S4.

In one exemplary operation, the client server 104 may first transmit the data stream 202 packet 1, and also transmit the first stack message S1, thereby indicating the initial data encryption mode which should be used to decrypt the first data stream 202 packet (packet 1) to the client front end 102. For example, the initial data encryption mode may be 256 bit RSA. The client server 104 next transmits the data stream 202 packet 2. However, no messages are sent from the encryption notification stack 204, thereby indicating to the client front end 102 to continue using the original encryption mode to decrypt the data stream 202 packet 2. The client server 104 next transmits the data stream 202 packet 3, and also transmits the third stack message S3, thereby notifying the client front end 102 of the new encryption mode. In one embodiment, the new encryption mode may be more secure than the initial encryption mode (e.g., 512 bit RSA) as is advantageous when transferring personal information. In other embodiments, the new encryption mode may be less secure (e.g., 128 bit RSA), thereby allowing more data throughput.

As those skilled in the art are aware, a TCP packet contains a header portion and a data portion. In other embodiments, the stack messages of the encryption notification stack 204 may be incorporated into the header of the data packets, thereby being sent in a single transmission. Alternatively, the stack message may be embedded at the beginning or end of the data portion, wherein the client front end 102 is expecting such and configured to parse the stack message from the other data.

In one embodiment, the user may determine which encryption mode the system 100 is to operate in. In other embodiments, the encryption mode may be changed on-the-fly or as-necessary depending on one or more metrics. Such metrics may include, for example and without limitation, overall latency, length of time to encrypt and decrypt messages, and/or quantity of data throughput. Further metrics may include various system performance metrics, such as CPU load, for example, if the encryption or decryption is using too much CPU, the encryption mode may be reduced to ease the CPU requirement.

In further embodiment, the system 100 may monitor data security threats, for example, detection of numerous incorrect logins signaling a possible hacking attempt. Resulting therefrom, the system 100 may change the encryption mode, likely increasing the encryption mode to further secure the transfer of data.

In further embodiments, it will be appreciated that the encryption mode may differentiate between a sending and receiving stream. For example, the data stream from the client server 104 to the client front end 102 may be 128 bit RSA, while the data stream from the client front end 102 to the client server 104 may be more secure at 256 bit RSA. Such may be advantageous as transfer from the client front end 102 to the client server 104 may contain passwords and/or other keystrokes which one prefers to assure higher security standards when transmitting. Moreover, such may be accomplished due to transferring less data as compared to the quantity being sent from the client server 104 to the client front end 102.

It is also known to those skilled in the art that each packet of the encrypted data stream 202 may have a unique ID. Therefore, the change in encryption mode may correspond with beginning a new encryption mode with a particular packet ID.

In even further embodiments, the encryption mode may be controlled by a central computer or server. For example, the authentication server 106 (FIG. 1) may synchronize with the client server 104 and the client front end 102 to coordinate changing the data encryption mode. Moreover, the central computer (e.g., authentication server 106) may control the network of an entire company, thereby applying data encryption mode changes globally throughout the company. Advantageously, such embodiments allow the encryption notification stack 204 to be a completely separate pipe from the encrypted data stream 202.

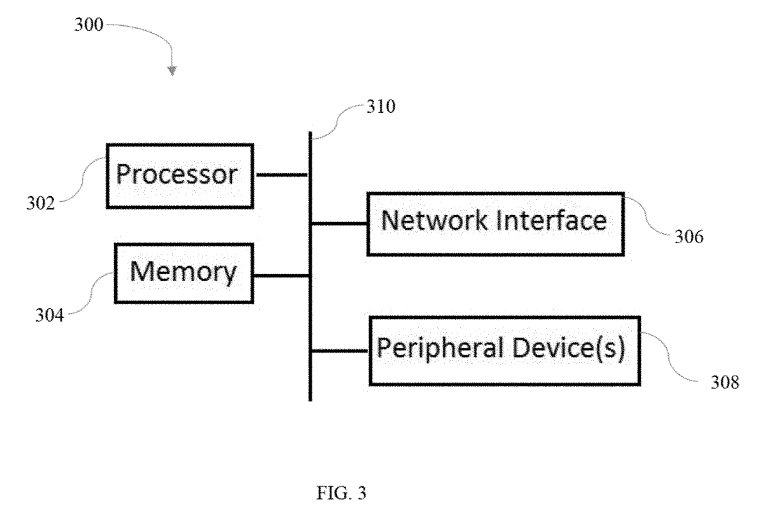

FIG. 3 depicts a block diagram 300 of a computing device that may be employed as one or more of the client front end 102, client server 104, and/or authentication server 106, according to one or more embodiments. In the embodiment depicted, the diagram 300 includes a processor 302, a memory 304, a network interface 306, and one or more peripheral device(s) 308.

The processor 302 may be comprised of, for example and without limitation, one or more processors (each processor having one or more cores), microprocessors, field programmable gate arrays (FPGA' s), application specific integrated circuits (ASICs) or other types of processing units that may interpret and execute instructions as known to those skilled in the art. Thus, the processor 302 may be comprised of a central processing unit (CPU) and an accelerated processing unit (APU) or graphics processing unit (GPU), thereby enabling increased ability to perform graphics processing.

The block diagram 300 further includes various types of memory 304, such as a hard drive and/or random access memory (RAM). Hard drive(s) may be any type of memory known to those skilled in the art capable of storing data or executable instructions thereon for a prolonged period of time, and continuing to store such should power to the computer (e.g., the client front end 102, client server 104, or authentication server 106) be turned off. Examples of such include, without limitation, all variations of non-transitory computer-readable hard disk drives, inclusive of solid-state drives. Other embodiments of the memory 304 may alternatively or additionally include random access memory (RAM). RAM may be external to computer, or in other embodiments be internal (e.g., “on-board” memory) to computer, and work in coordination with any hard drive to store and/or execute programs and/or process graphics data, etc. Example embodiments of RAM may include, without limitation, volatile or non-volatile memory, DDR memory, Flash Memory, EPROM, ROM, or various other forms, or any combination thereof generally known as memory or RAM.

The network interface 306 may be any interface capable of sending and receiving data via a network. Examples may include, but are not limited to, hard-wired network interface card(s) (NIC), and/or wireless network interfaces, including those capable of transmitting data over a cellular provider network. The network interface 306 may be configured to communicate over one or more of a local area network (LAN), wide area network (WAN), cellular provider network (or “mobile network”), along with “cloud” networks.

The peripheral device(s) 308 may include, for example and without limitation, a keyboard, mouse, and/or display. For example, the client server 104 and authentication server 106, which, in at least one embodiment are hosted on the same computer, may initially be configured or updated via a locally connected mouse, keyboard, and/or monitor. Alternatively, such may be remotely configured, for example, via a remote login over a network. The client front end 102 may vary from a desktop computer, to a portable computing device such as a laptop, tablet, iPad, etc., to a cellular device. Therefore, in some embodiments, the peripheral device 308 may include a touch screen display or embedded display (e.g., mobile devices).

One or more of the processor 302, memory 304, network interface 306, and peripheral device(s) 308 are communicably coupled via one or more busses 310.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein.

Also, the terms in the claims have their plain, ordinary meaning unless otherwise explicitly and clearly defined by the patentee. Moreover, the articles “a” or “an,” as used in the claims, are defined herein to mean one or more than one of the element that it introduces. As used herein the term “and/or” and “/” includes any and all combinations of one or more of the associated listed items. While compositions and methods are described in terms of “comprising,” “containing,” or “including” various components or steps, the compositions and methods can also “consist essentially of” or “consist of” the various components and steps.

It will be understood that the sizes and relative orientations of the illustrated elements are not shown to scale, and in some instances they have been reduced or exaggerated for purposes of explanation. Additionally, if there is any conflict in the usages of a word or term in this specification and one or more patent or other documents that may be incorporated herein by reference, the definitions that are consistent with this specification should be adopted.

What is claimed is:

1. A system/method for changing in real time the encryption methods and encryption complexity of an active data stream without adverse disruption to that data stream.

2. A method of claim 1, further comprising: Creating a pathway (over a network or over other non-network pipelines and or communications channels) to support the transfer of supplemental encryption data and configuration to allow the encryption level to be changed pre stream, mid-stream or in some cases post stream (for example when buffering).

3. A method of claim 1, further comprising: An encryption and decryption method prior to and after receiving the encrypted transmission or series of encrypted transmissions or sub part of the encrypted transmission (such as a network packet or network packet series or partial network packet in cases where multiple encryption/decryption methods are utilized in a single packet) which implements claims 1 and 2.

4. A method to inform the destination decryption system in claim 3 the precise timing of the start of the ‘next’ encryption methodology to ensure synchronization.
